(19) United States
(12) Patent Application Publication
(10) Pub. No.: US 2010/0243973 A1
(43) Pub. Date: Sep. 30, 2010

(54) SCISSOR-TYPE LIFTING PLATFORM

(75) Inventors: Thomas Deuring, Hopferbach (DE); Thomas Grötzinger, Immenstadt (DE); Jürgen Grotz, Wiggensbach (DE)

Correspondence Address: BLAKELY SOKOLOFF TAYLOR & ZAFMAN LLP, 1279 OAKMEAD PARKWAY, SUNNYVALE, CA, 94085-4040, US

(73) Assignee: MAHA MASCHINENBAU HALDENWANG GMBH & CO. KG, Haldenwang (DE)

(21) Appl. No.: 12/600,562

(22) PCT Filed: May 16, 2008
(86) PCT No.: PCT/DE08/00837

§ 371 Date: May 17, 2010

(30) Foreign Application Priority Data
May 18, 2007 (DE) 10 2007 023 184.0

(51) Int. Cl. B66F 3/22; B66F 7/06

(52) U.S. Cl. 254/122

(57) ABSTRACT

The invention relates to a scissors-type lifting platform, in particular for vehicles: including: stationary support rails on or in the floor level, at least two scissors arms which cross each other and are retained and guided with their bottom ends in the support rails, a hinge connecting the two scissors arms approximately centrally to each other, a lifting assembly engaging the scissors arms for spreading and contracting the scissors arms, at least one travel rail having contact areas and supported on the top ends of the scissors arms, wherein one of the scissors arms is connected to a travel rail with its top end in hinged manner and the other scissors arm is guided on the travel rail with its top end in longitudinally displaceable manner upon the lifting and lowering movement of the scissors-type lifting platform, characterized in that the longitudinally displaceable ends of the two scissors arms (12, 13; 20, 21) can be arrested with the associated travel rail (28) at least in the lifted position.

The invention relates to a scissors-type lifting platform, in particular for vehicles, including two support and floor rails, respectively, secured on or in the floor, including at least two scissors arms which cross each other and are retained and guided in the support rails with their bottom ends, including a hinge approximately centrally connecting the two scissors arms to each other, including a lifting assembly engaging with the scissors arms for spreading and contracting the scissors arms, and including bearing and travel rails, respectively, having contact areas for e.g. vehicle wheels in their end regions and supported on the top ends of the scissors arms, wherein one of the scissors arms is hinged respectively on one bearing rail with its top end, and the other scissors arm is longitudinally displaceably guided on the bearing rail with its top end upon lifting and lowering.

Scissors-type lifting platforms are employed in different technical fields for lifting various loads and optionally also persons. Corresponding to their preferred purpose of use, a plurality of constructive solutions are in use, for example as load lifters in high-bay rackings, as fixed or also mobile working stages, fork lift trucks or the like. Different implementations of scissors-type lifting platforms are also employed for lifting motor vehicles, in particular cars, off-road vehicles and transporters, in repair shops, in manufacturing plants and also in test facilities due to the simple lift technology, the robust construction and the possibility of a ground-level arrangement of the retracted scissors-type lifting platform.

Known scissors-type lifting platforms for lifting motor vehicles as they are employed in repair shops, test facilities or the like for lifting lower-weight motor vehicles such as cars, off-road vehicles, transporters etc. usually have two support and guide rails, respectively, of reshaped flat rolled steel or sheet fixedly disposed on the floor or underfloor in the ground. The intermediate distances of these two parallel support rails approximately correspond to the wheel bases of the vehicles to be lifted. In an end region of each one of these support rails, a bearing assembly is provided, on which the bottom end of a scissors arm is supported in hinged and non-displaceable manner. The bottom end of the second scissors arm is guided in longitudinally displaceable manner and hingedly supported in longitudinal guides of the support rails. Both scissors arms are pivotally connected to each other in their central region by a journal. A bearing rail is supported on the top ends of each scissors arm pair. Since the two scissors arms of each pair of scissors arms are centrally connected to each other, the respective bearing and travel rail, respectively, extends substantially horizontally. The top end of each one scissors arm is hingedly secured to an end region of the bearing rail and the top end of the other scissors arm is guided in longitudinally displaceable manner in guide elements of the bearing rail upon spreading and contracting the bearing arms.

In this type of lifting platform, certain instabilities and non-exact horizontal orientations of the upper bearing rails mostly referred to as travel rails in car lifting platforms can arise under load. The cause of this possibility of error is the support of the top ends of the one scissors arms displaceable in longitudinal direction. Upon load, the travel rail can slightly lower on one side, whereby it is deflected from its alignment parallel to floor. If axle alignments of vehicles are to be performed on a scissors-type lifting platform, this slight inclination of the travel rails can result in corresponding incorrect measurements. Up to now, such behavior of scissors-type lifting platforms was counteracted by a more robust construction with increased cost of materials.

It is the object of the invention to provide a scissors-type lifting platform ensuring improved stability and rigidity even in case of asymmetric loads without excessive overhead and cost.

According to the invention, this object is solved by the features indicated in claim 1.

In the scissors-type lifting platform according to the invention, in a fully or partially lifted position, the bottom and also the top ends of all of the scissors arms are arrested on the associated support and bearing rails, respectively, such that the travel rails are fixed and supported on fixed points symmetric to the vertical center plane. Thereby, inclinations of the travel rails under higher load are reliably avoided even in case of asymmetric load distribution such that axle alignments of a resting vehicle can be performed with high precision.

As a preferred means for arresting the top ends of the one scissors arm on the associated travel rail, conveniently, a locking mechanism is used which has a slide element longitudinally guided on the profiled travel rail and at least one locking element which can be arrested in form-locking or force-locking manner on the travel rail. Conveniently, the longitudinally guided slide element is formed and disposed such that it is able to absorb the load forces exerted by the vehicle through the travel rail to the arresting and locking mechanism, respectively, without excessively great friction contact upon the lifting and lowering movements.

According to a convenient configuration, the arresting mechanism has front and rear slide elements guided inside the profiled travel rail as well as front and rear locking elements collectively operable, as well as further a central bearing assembly, on which the top end of the scissors arm is hinged approximately symmetrically between the slide elements and the locking elements. By this configuration, a sufficiently elongated guide between the travel rail and the arresting and locking mechanism is achieved, respectively, and in the arrested state, a dual locking is effected by means of the front and rear locking elements which act on counter-members fixed to the travel rails in form-locking manner as claws or teeth and in friction-locking manner as wedges, respectively. Since the bearing assembly of the top end of the pivot arm is disposed symmetrically between the front and rear slide elements as well as the front and rear locking elements, symmetric distribution of the friction forces is effected upon lifting or lowering as well as of the locking forces upon arresting.

According to a further convenient configuration of the invention, the locking elements of the respective locking mechanism are collectively and simultaneously operated by a drive, wherein an electric, mechanic or fluidic linear drive can be employed for this operation of the locking elements.

An effective and reliable operation of the locking elements is advantageously achieved with a drive assembly attached to a front end of a box-shaped housing, on which the slide elements, the locking elements and in the central portion the supporting bearing for hinging the top end of the scissors arm are provided. In this configuration, the simultaneous operation of the front and rear locking elements is effected with the aid of a slider which is displaced by the drive in the housing via a tappet and has operating elements for pivoting the locking elements from their engagement position against the force of leaf springs.

As counter-members for the tooth-like locking elements, toothed racks can be employed which are attached to the side plates of the travel rails with teeth facing inwards. If the arrest between the top end of the scissors arm and the travel rail is effected by friction-contact, for example by wedge effect, instead of the toothed racks, there can be employed a beam rigid in shape with high friction coefficient and shaped wedges as the locking elements in suitable manner.

Furthermore, the scissors-type lifting platform can be characterized in that an arresting mechanism is hinged on the top and/or bottom end of a scissors arm which can have a locking element which can be arrested in form-locking and/or force-locking manner on the travel rail and/or on the guide rail, and a catch element, wherein the catch element can have a plurality of substantially similarly formed catches, wherein the locking element can be engageable in a plurality of catching positions with at least one catch in detachable, form-locking and/or force-locking manner. Therein, at least in a partial region, at least a first catching position, a second catching position and a third catching position can be approachable with the locking element, wherein at least a first distance between the first catching position and the second catching position and a second distance between the second catching position and the third catching position can have different lengths. The person skilled in the art is familiar with the fact that by corresponding numbering of the catching positions, at least a first distance between the first catching position and the third catching position and a second distance between the second catching position and the first catching position can have different lengths. The arresting device can further have a force element for producing a relative movement between the locking element and at least one catch. Therein, in at least a partial region of the catch element, the catches can have distances different from each other. Thereby, in particularly simple manner, the number of possible catching positions can be reduced to a lower number of predetermined catching positions, thereby considerably reducing the expenditure of time for locating the equidistant catching positions.

Furthermore, the catch element can be connected to the guide rail, the travel rail and/or to a workshop floor, wherein the catches of the catch element can have a different pitch in longitudinal direction of the catch element.

Furthermore, the catch element can have a first partial region, in which the first distance between two adjacent catches and the second distance between two adjacent catches are the same, and can have a second partial region, in which the first distance between two adjacent catches and the second distance between two adjacent catches are different, wherein the length values of the distances between each two adjacent catches in longitudinal direction of the catch element increase or decrease continuously, steadily, suddenly and/or discontinuously. From this, there arises the advantage that a plurality of different catching positions are approachable within a certain starting height and only a smaller number of predetermined catching positions can be occupied outside of this starting height.

Furthermore, with increasing lifting height of the lifting platform, substantially in a vertical direction, the pitch of the catch element can increase substantially in horizontal direction.

Furthermore, a guide unit can be provided which can be connected to the catch element such that the locking element can be engaged with the catch element exclusively in predetermined positions. From this, advantages arise in that the locking element can only engage with the catch element in predetermined catching positions, and thereby faulty catching between the locking device and the catch element is excluded. Moreover, the guide unit offers the advantage that even in case of use of a catch element the adjacent catches of which have distances equal to each other over the entire length of the catch element, catching positions can be predetermined characterized in that the distances of adjacent catching positions have different length. In similar manner, in the partial region of the catch element, in which adjacent catches have equal distances to each other, it can also be ensured by means of the guide unit that the locking unit can only occupy catching positions in this region which have distances different from each other.

Furthermore, the guide unit can have an outer contour and the locking element can have an operating means which can be brought into contact with the contour of the guide unit in predetermined positions, whereby a contact between the locking element and the catch element can be prevented in these positions. This offers the advantage that different catching positions are adjustable even afterwards by changing the contour or by use of an exchangeable guide means.

Furthermore, the catch element can be a toothed rack and the catches can be teeth, wherein the locking element can have at least one tooth engageable with least one tooth of the toothed rack. Furthermore, the catch element can be a perforated rail.

Furthermore, the force element can be a hydraulic cylinder, a stepper motor, an electromagnetic actuator, a spring element and/or a pneumatic cylinder.

Furthermore, the arresting mechanism can have a housing rigid in shape which can be connected to the locking element via a rotary joint, wherein a first end region of the force element can be connected to the locking element and a second end region of the force element can be connected to the housing.

Furthermore, the locking element can have at least a first tooth and a second tooth, wherein the catches can have a first catch unit and a second catch unit, wherein a first tooth and/or a second tooth can be engageable with a first catch unit and/or a second catch unit, respectively. By the use of a catch with two catch units as well as a locking element with two teeth, a dual engagement and thus a particularly secure arrest can be ensured.

Furthermore, the scissors-type lifting platform can have a controller, by which the lifting assembly can be controlled during a lifting operation such that the travel rail reaches a first predetermined lifting height by a lifting movement, and after reaching this lifting height, it reaches a second predetermined lifting height by a lowering movement. Thereby, in particularly simple manner, complete and secure arrest of the locking mechanism with the catch element can be ensured.

Furthermore, after reaching the first predetermined lifting height and before and/or during reaching the second predetermined lifting height, the force element of the arresting mechanism can be controllable by the controller such that the locking element can be engaged with the toothed rack in form-locking and/or force-locking manner.

Furthermore, at least before and/or during reaching the second predetermined position, a force element of the locking element can operate such that the locking element can be engaged with a catch of the catch element in form-locking and/or force-locking manner, and thereby the second predetermined position corresponds to an arresting position.

Furthermore, for releasing the engagement between the locking element and a catch, the controller can control the drive assembly such that first a lifting movement can be produced, and subsequently, a lowering movement can be produced. Therein, between the end of the lifting movement and the beginning of the lowering movement, and/or during the lifting or lowering movement, the force element can be controllable by the controller such that the form-locking and/or force-locking engagement of the locking element with a catch of the catch element is released. Thus, in particularly simple manner, complete release of the locking mechanism and of the catch element can be ensured.

In summary, in the following, the advantages of the invention are to be enumerated over again. By providing a catch element, the individual catches of which have a different pitch at least in a partial region of the catch element, it can be ensured that the predetermined lifting positions, in which a lifting platform can be arrested, have an equidistant, vertical distance to each other, although the locking element performs different path lengths from catching position to catching position in lateral direction. By providing a guide unit, it can be ensured in particularly simple manner, that unintended catching of the locking element to the catch element can occur. This is in particular advantageous in case of use of a locking element with two teeth and a catch with a first catch unit and a second catch unit, in which the danger can arise that a second tooth can unintentionally get caught to a first catch unit. This problem in particular arises upon insufficient pressurization of the force element, whereby the locking element is not completely retracted into the housing, and by the different pitch, the second tooth of the locking element can get jammed on a second catch unit and thus it can result in inefficiency of the entire lifting platform. Further, thereby, it can also be ensured that incomplete unlocking of the locking mechanism, in which both teeth of the locking element remain in contact with the catch, is prevented, thereby avoiding blockage of the lifting installation.

In the following, a scissors-type lifting platform for motor vehicles is described in detail as an embodiment of the invention based on the drawing, wherein

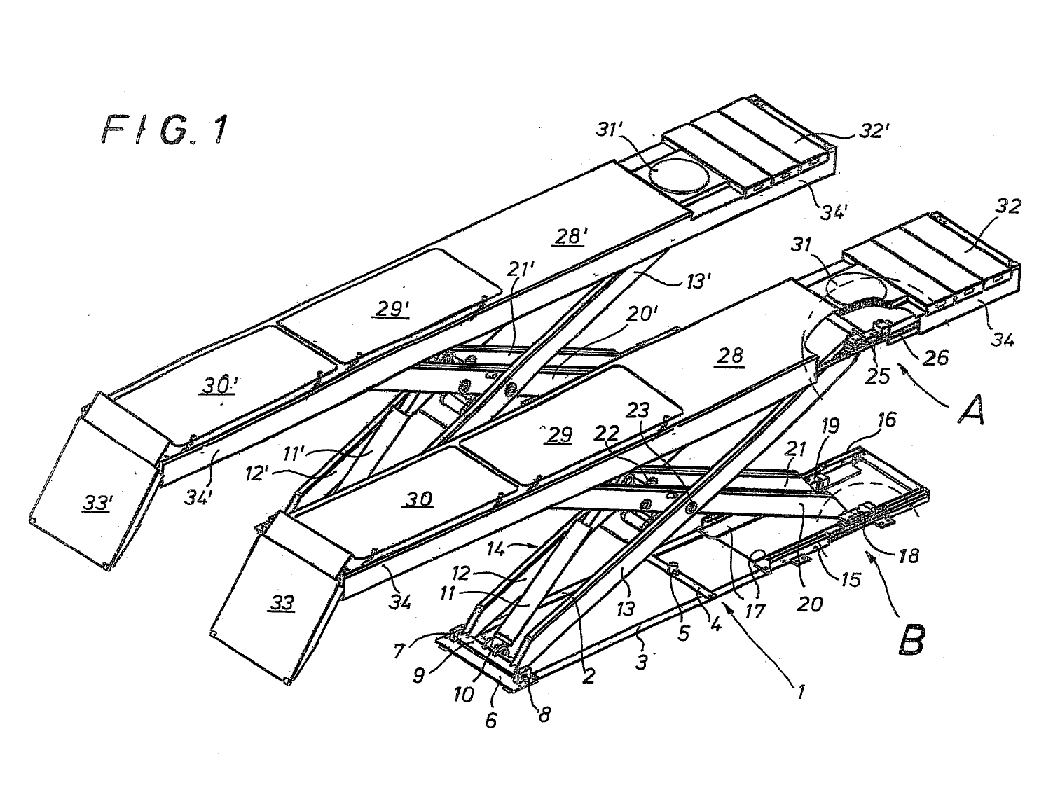

FIG. 1 shows a scissors-type lifting platform for motor vehicles in perspective representation,

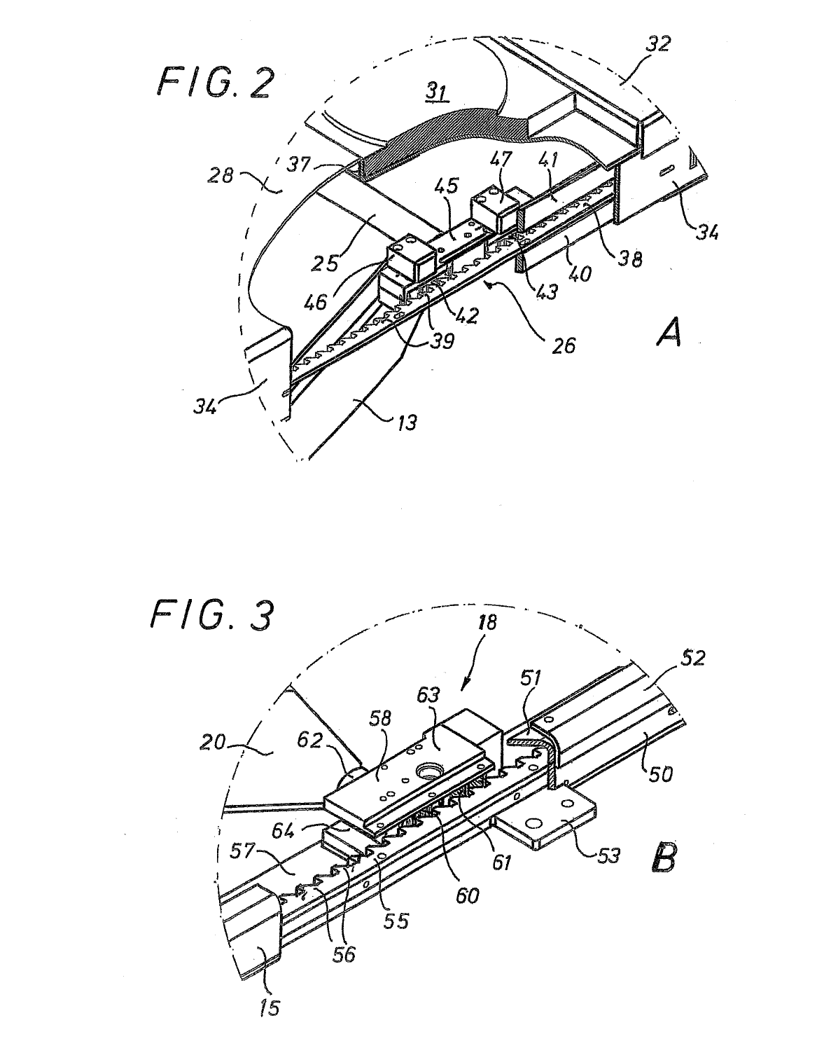

FIG. 2 shows an enlarged section A in FIG. 1,

FIG. 3 shows an enlarged section B in FIG. 1,

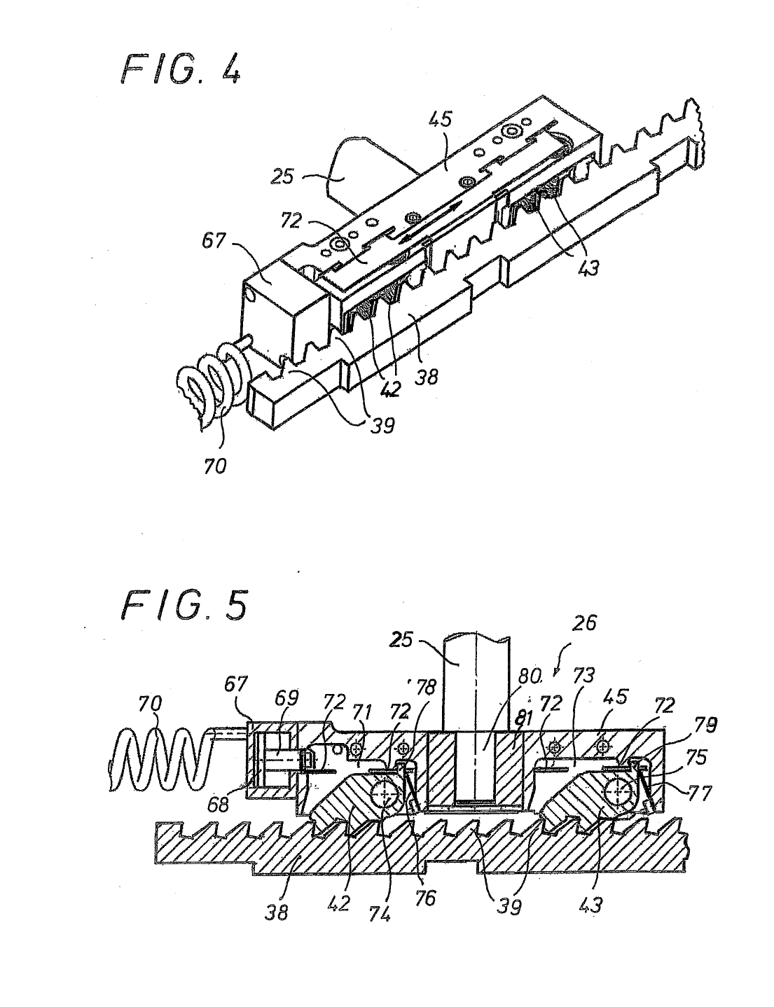

FIG. 4 shows a portion of the locking mechanism employed in the scissors-type lifting platform according to FIG. 1 in perspective representation,

FIG. 5 shows the portion of the locking mechanism according to FIG. 4 in cross-section,

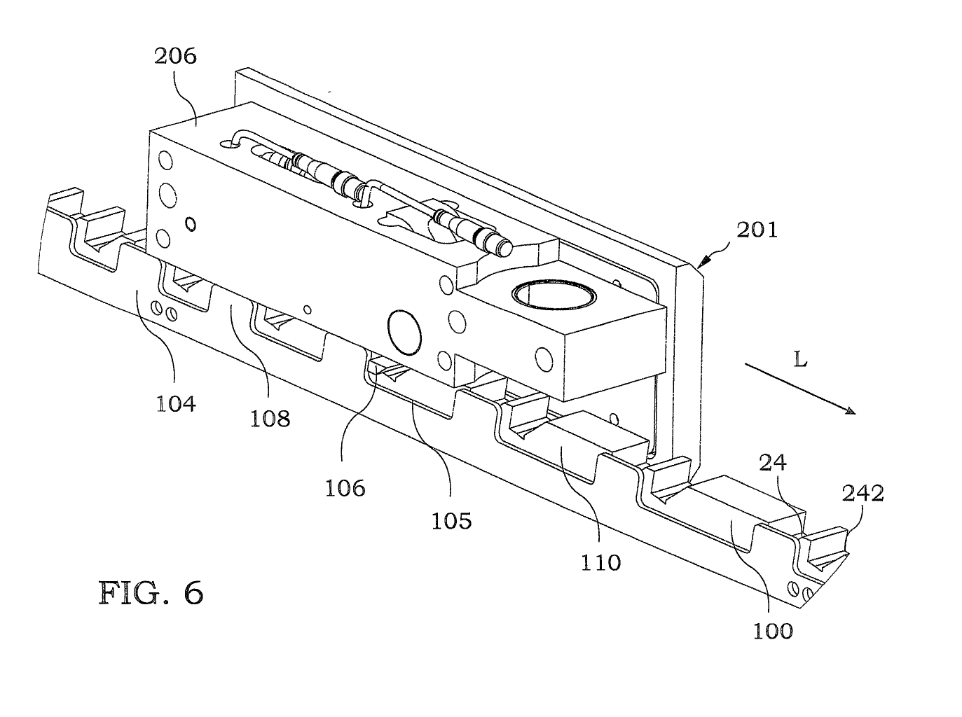

FIG. 6 shows a perspective view of the arresting device,

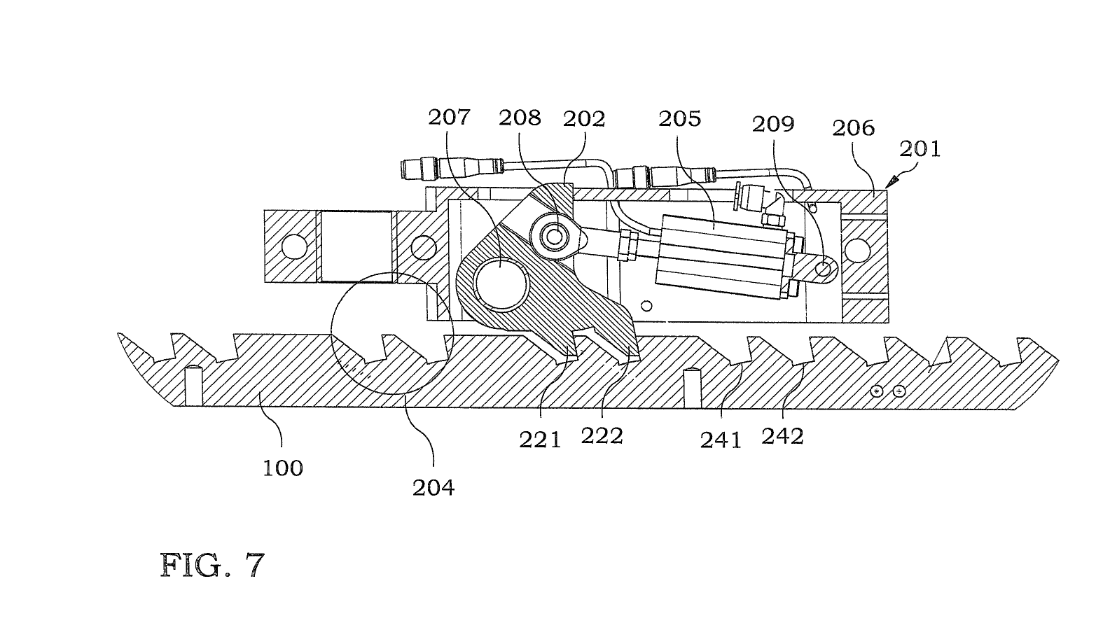

FIG. 7 shows a longitudinal section through the arresting device,

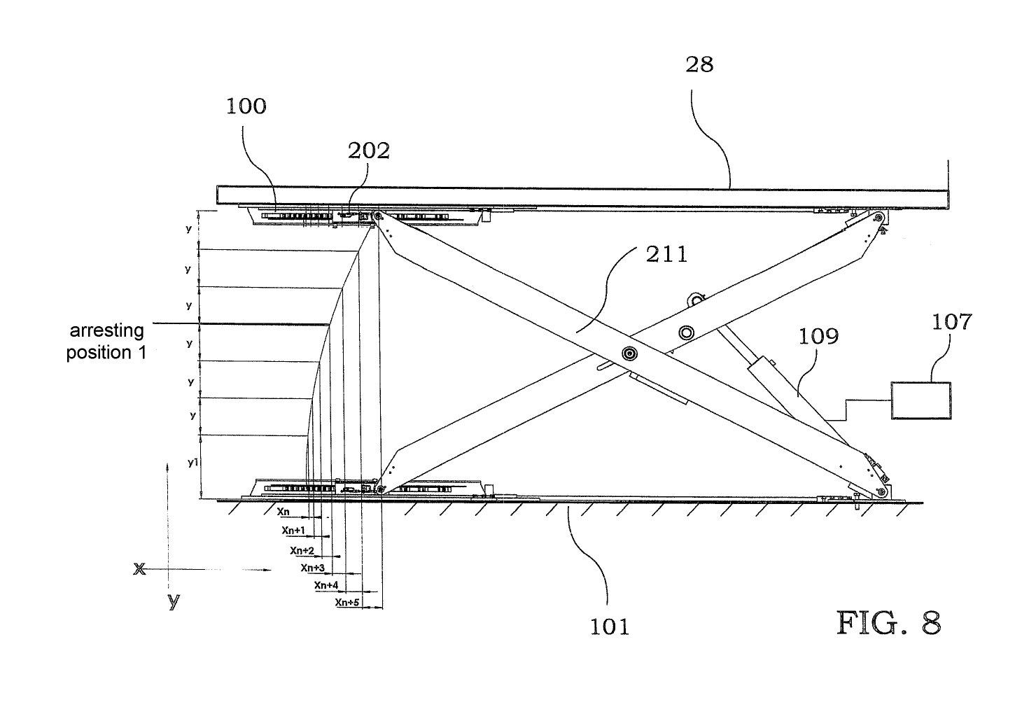

FIG. 8 shows a scissors-type lifting platform with arresting device according to the invention,

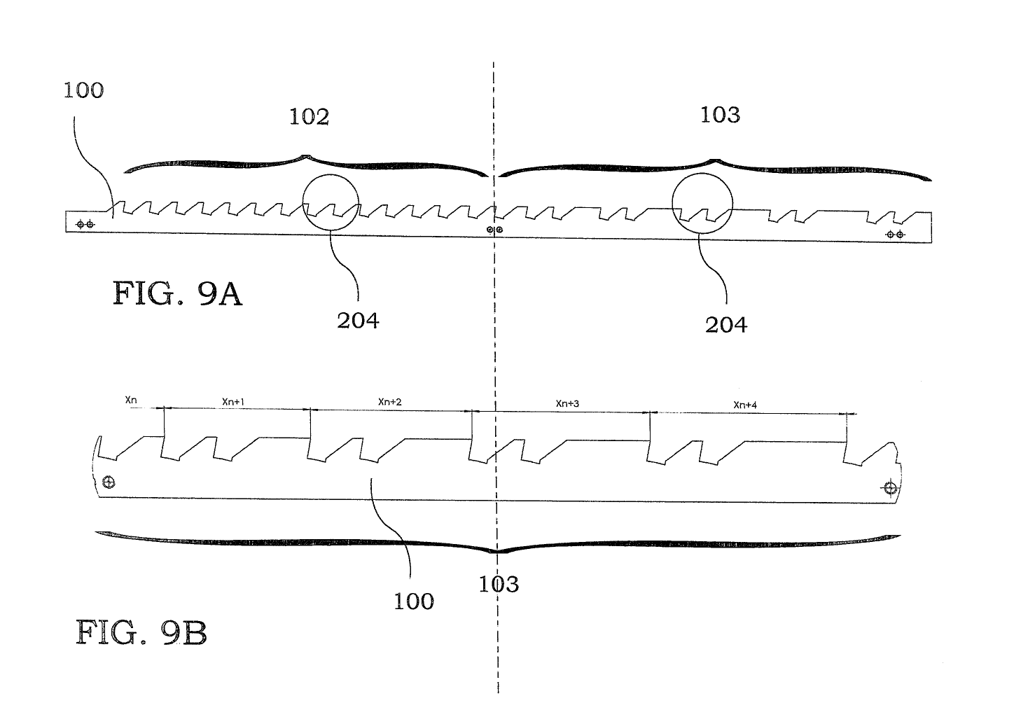

FIG. 9A shows a side view of the catch element,

FIG. 9B shows a side view of the second partial region of the catch element.

The scissors-type lifting platform illustrated in FIG. 1 serves for lifting lower-weight motor vehicles, in particular cars, off-road vehicles, vans etc. The lifting platform has two support rail constructions 1, only one of which is visible in FIG. 1 and the second one of which is hidden. In the left half in FIG. 1, the support rail construction 1 is composed of two longitudinal supports 2, 3 parallel to each other which are connected by a crossbar 4 in their central region, to which a central stud 5 is attached. The left end portions of the two longitudinal supports 2, 3 in FIG. 1 are fixedly connected to each other by an approximately plate-shaped crossbeam 6, to which two bearing blocks 7, 8 are each attached on the end side. In these bearing blocks 7, 8, a horizontal rotary bolt 9 is supported with its ends, to which a supporting hinge 10 for hinged support of a pressure medium cylinder 11 is centrally attached. Immediately next to the insides of the two bearing blocks 7, 8, two narrow support arms 12, 13 which are rigid in shape and have tapered end portions are attached to the rotary bolt 9 which together constitute a scissors arm 14.

The right part of the support rail construction 1 in FIG. 1 contains two parallel longitudinal rails 15, 16 each having a cross-section open inwards and connected to a floor-side flat iron 17. On each of the lateral support and guide rails 15, 16, respectively, an arresting or locking mechanism 18, 19 is each provided which is hingedly connected to the tapered bottom ends of each one support arm 20, 21. These two support arms 20, 21 collectively constitute a second scissors arm. As illustrated, the two support arms 13 and 20 as well as the two support arms 12 and 21 are each hingedly connected to each other by central bearing bolts 22, 23. The piston of the pressure medium cylinder 11 engages with a transmission pivot lever linkage mechanically coupled to the two crossed scissors arms. If the pressure medium cylinder 11 is pressurized with pressure fluid and thereby extends its piston rod, spreading of the two scissors arms is effected.

The tapered top ends of the two support arms 12, 13 constituting the first scissors arm 14 are connected to each other by a crossbolt 25. Each end of this crossbolt 25 is pivotally supported in an arresting and locking mechanism 26, respectively which is described in the following in more detail with reference to FIG. 2. In the FIGS. 1 and 2, only one of the two arresting mechanisms 26 is respectively illustrated which constitute end-side bearing assemblies for the cross and bearing bolt 25, respectively. These two arresting mechanisms 26 are formed mirror-inverted equally such that only one mechanism is described by way of FIG. 2.

As shown in FIG. 1, on the top ends of the support arm pairs 12, 13 and 20, 21 constituting the two scissors arms, a bearing and travel rail 28 is respectively supported which carries two front-side contact areas 29, 30 on its top as well as a turntable 31 as well as transverse plates 32 on its rear end part. At the front, left end of the travel rail 28 in FIG. 1, an access ramp 33 is articulated. The travel rail 28 has a plane upper surface as well as two vertically angled sidewalls 34, only the front one of which is visible.

Above, only one half of the scissors-type lifting platform illustrated in FIG. 1 was described. The second half of this lifting platform is configured equal in construction and disposed in a horizontal intermediate distance which approximately corresponds to the track width of a motor vehicle to be lifted. The front and rear half in FIG. 1 together constitute the scissors-type lifting platform for lifting and lowering a motor vehicle. The rear half in FIG. 1 of the scissors-type lifting platform has the same components as the front half which are identified with the same reference characters—provided with an index mark.

A vehicle to be lifted travels with its wheels over the ramps 33, 33′ onto the lowered travel rails 28, 28′. For aligning e.g. the wheel axles of the motor vehicle, the wheels are positioned on the contact plates 29, 29′, 30, 30′ and 31, 31′, respectively, and the lifting platform is lifted into its lifted position by controlled pressure medium supply to the pressure medium cylinders 11, 11′. In the preset extension position which is e.g. illustrated in FIG. 1, the arresting mechanisms 18, 19 in the floor region and the further arresting mechanisms 26 on the upper travel rails are activated such that the scissors arms and therewith the entire scissors-type platform are fixed in the respectively selected position. By this activation of the arresting mechanisms 18, 19 and 26, slight longitudinal displacements of the bearings at the bottom ends of the scissors arms 20, 21; 20′, 21′ as well as also of the bearing assemblies at the top ends of the scissors arms 12, 13; 12′, 13′ are also prevented such that the right parts of the travel rails in FIG. 1 cannot even slightly tilt under load either.

FIG. 2 shows the section A in FIG. 1 in enlarged scale, in which one of the arresting mechanisms 26 for fixing the top end of the one support arm 13 to the travel rail 28 is illustrated. The two sidewalls 34 are integrally bent downwards from the plane top of the travel rail 28, wherein a suitable frame construction with support plate can also be chosen. In a depression 37 of the top of the travel rail 28, the turntable 31 with the circular contact area is disposed. The cross and bearing bolt 25, respectively, connected with each one end to a tapered end portion of the support arm 13 and to an arresting mechanism 26 extends from the angled depression 37. One toothed rack 38 with teeth 39 facing inwards is each attached to each sidewall 34 of each travel rail 28 which extends between two upright narrow cut plates 40, 41 and the back of which faces the inside of the sidewall 34. This toothed rack 38 is permanently attached to the inside of the associated sidewall 34 of the travel rail by suitable means such as screw bolts, welded joints or the like and constitutes the fixed part of the arresting mechanism 26. With the teeth 39 facing inwards of the toothed rack 38 fixed to the travel rail 28, each two tooth claws 42, 43 are engaged which e.g. in FIG. 5 are illustrated enlarged in cross-section. These tooth claws 42, 43 are pivotally supported in an elongated rectangular stable housing 45 such that their teeth 46 can engage with corresponding tooth gaps of the toothing 39 in the toothed rack 38 (cf. FIGS. 4, 5). On the top of the housing 45, a plurality of slide elements 46, 47 are attached which are formed as compression-proof slide blocks in the present case, on the optionally coated sliding surfaces of which the travel rails 28 rest. The weight forces of the loaded and also unloaded travel rails 28, respectively, are transferred through the slide elements 46, 47 and the correspondingly stabile housing 45 and the bearing bolt 25 into the respective scissors arms.

FIG. 3 shows the support of the lower tapered end portion of the scissors arm 20 in enlarged manner in section B in the support rail 2 in FIG. 1. The longitudinal rail 15 has a vertical wall section 50 and an upper section 51 bent into the horizontal, wherein the region of the bend is covered by an exterior arcuate sheet 52. On the vertical wall section 50 of the longitudinal rail 15, a laterally horizontally protruding plate 53 is attached, in which securing bores are provided. On the inside of the vertical wall section 50, an elongated toothed rack 55 with a toothing 56 facing inwards is attached which extends on the exterior lateral region of an elongated narrow bottom plate 57. The toothed rack 55 constitutes the fixed portion of the arresting mechanism 18, by which the bottom end of each one of the scissors arms is detachably fixed to the associated support and floor rail, respectively. This fixation is effected by two tooth claws 60, 61 pivotally supported in a housing 58 one behind the other which constructively and functionally correspond to the tooth claws 42, 43 illustrated in FIG. 5 in cross-section of the upper arresting mechanism illustrated in FIGS. 1 and 2. The tapered bottom end of the associated scissors arm 20 is rotatably supported in the housing 58 through a crossbolt 62. A slide plate 64 is disposed on the housing 58 which ensures an exact straight guidance of the arresting mechanism with disengaged inactive tooth claws.

In the FIGS. 4, 5, the upper arresting mechanism according to section A in FIG. 1 is shown in a perspective representation and in horizontal section, wherein the slide elements 46, 47 attached to the housing 45 according to FIG. 2 are not illustrated. On the left end side of the housing 45 in FIGS. 4, 5, a drive element 67 is attached which is formed here as a pressure medium cylinder with a piston 68 and piston rod 69 centrally attached thereto. The cylinder 67 is provided with pressure medium through a towing line 70 variable in length. The free end of the piston rod 69 protrudes into a free space 71 in the housing 45 and is fixedly connected to a slider 72 formed of an elongated cut sheet via a screw which is completely illustrated in FIG. 4 in top view. In FIG. 5, the various individual parts of the slider are each provided with the reference character 72. In the free space 71 of the housing, the double-tooth claw 42 and in a second free space 73 in the housing 45 on the other side of the bolt 25, the second double-tooth claw 43 is supported pivotally about a bolt 75. The two double-tooth claws 42, 43 are continuously loaded with an engagement force respectively exerted by a leaf spring 76, 77. Each one of these leaf springs 76, 77 presses with its top end against each one lug 78, 79 formed pointing upwards in the upper right corner region on each double-tooth claw 42, 43. Each leaf spring 76, 77 presses to the backside of the associated lug 78, 79 and exerts a torque acting in closing direction on the associated double-tooth claw 42, 43 such that the teeth thereof engage with the tooth gaps of the toothed rack 38. As is apparent from FIG. 5, the teeth 39 of the toothed rack 38 and also the teeth of the two double-tooth claws 42, 43 are formed asymmetrically such that upon movement of the crossbolt 25 with the housing 45 in FIG. 1 to the right, the teeth of the double-tooth claws 42, 43 slide out of the corresponding tooth gaps of the toothed rack 38 against the force of the leaf springs 76, 77. By pressurizing the cylinder 67 with a pressure medium, the piston 68 thereof is displaced to the right in FIG. 5, whereby its piston rod 69 pushes the slider 72 to the right and thereby presses against each one of the lugs 78, 79 on the tooth claws 42, 43. This pressure results in a simultaneous and common opening pivoting movement of the two tooth claws 42, 43 whose teeth are released from the toothing 39 of the toothed rack 38.

The crossbolt 25 has a narrower stud 80 at each end which is rotatably supported in a recess in the housing 45 via a bearing bush 81.

In FIG. 6, an arresting device 201 is illustrated which has a housing 206 rigid in shape, in which a locking element 202 (non visible) is inserted. The locking element 202 can be engaged with a catch element 100. The catch element 100 has similarly formed catches 204 which each have a first catch unit 241 and a second catch unit 242. A guide unit 104 is provided on a lateral surface 110 of the catch element 100 which has flat elevations 108. The distances between the elevations 108 substantially correspond to the distances between the catches 204. The guide unit 104 is aligned on the catch element 100 such that its elevations 108 laterally cover each second catch unit 242 of the catches 204. Further, in FIG. 6, the operating means 106 is recognizable which is disposed on the locking element 202 and communicates with the guide unit 104. Upon a lateral movement of the locking mechanism 1 along the catch element in the direction of arrow L, the operating means 106 comes into contact with the contour 105 of the guide unit 104 in the region of the elevations 108. By this contact, the operating means 106 blocks the locking element 202 and thereby prevents extension of the locking element 202.

In FIG. 7, a lateral sectional view in longitudinal direction through the arresting device is illustrated. Inside the housing 206 rigid in shape, a force element 205 in the form of a hydraulic and pneumatic cylinder, respectively, is provided.

In an embodiment not illustrated, the force element can be a stepper motor, an electromagnetic actuator or a spring element.

The force element is connected to the housing 206 through a rotary joint 209 in a first end region and connected to the locking element 202 through a rotary joint 208 in a second end region. The locking element 202 is rotatably supported in the housing 206. By operating the force element 205, the locking element 202 can rotate around the rotation axis 207 and thereby be moved into the housing 206 and out of the housing 206, respectively, in order to thus be transferred into an arresting and unlocking position, respectively.

The locking element has two teeth, a first tooth 221 and a second tooth 222 which are each engaged with a first catch unit 241 and a second catch unit 242 of a catch in an arresting position.

FIG. 8 shows a side view of a scissors-type lifting platform, on which the arresting device according to the invention exemplarily finds use. The locking element 202 is mounted on a first component 211, namely on a laterally displaceable top end of a scissors arm 211. The catch element 100 is mounted on a second component 28, for example a travel rail 28. The first component 211, the scissors arm 211, is rotatably connected to a third component 101, a basement or a floor plate, at its bottom end.

A corresponding assembly is shown in FIG. 8 also for the second scissors arm, wherein a laterally displaceable bottom end is connected to the arresting mechanism and a top end rotatably is connected to the travel rail 28. The shown scissors-type lifting platform has uniform, vertical distances y for catching positions from a certain starting height y1 which can be approached by the lifting platform. In order to realize these equidistant distances, the catch elements 100 must have a different pitch of the teeth in horizontal direction. This pitch increases with increasing lifting height of the travel rail 28 in lateral direction, shown by the distances xn, xn+1, xn+2, x . . . , wherein xn<xn+1<xn+2<x . . . .

Furthermore, in FIG. 8, a controller 107 is seen which communicates with the lifting assembly 109. The lifting assembly is connected to the two scissors arms of the scissors-type lifting platform such that it can spread and contract the scissors arms with respect to each other, respectively, upon operation. On the one hand, the lifting assembly 109 and on the other hand the force element 205 in the locking mechanism 201 can be controlled by the controller 107.

If the lifting platform is to be lifted and arrested in an arresting position 1 which corresponds to a height resulting from the value y1+3·y, the controller 107 controls the lifting assembly 109 such that the lifting height is moved to a height which is substantially slightly higher than the arresting position 1, but lower than a lifting height composed of the value y1+4·y. If this first lifting height is reached, the force element 205 is controlled through the controller such that the teeth 221, 222 of the locking element enter the recesses of the catch units 241, 242, wherein the locking element 202 is rotated out of the housing 205. Subsequently, the lifting assembly 109 is controlled such that the travel rail performs a lowering movement and occupies the arresting position 1, wherein the teeth 221 and 222 are fixedly engaged with the catch units 241 and 242.

In order to remove the lifting platform from the catching position 1 and to release the arrest, the lifting assembly 109 is controlled such that first a slight lifting movement is performed, wherein the travel rail occupies a lifting height which is greater than the height value resulting from y1+3×y, and smaller than the height value resulting from y1+4×y, however at least so high that the locking element 2 can be transferred into a disengagement position. In this height, the force element 205 of the locking mechanism 201 is controlled such that the locking element 202 is rotated into the housing 206 and thereby occupies the disengagement position.

Although in FIG. 8 an arresting device according to the invention is provided at the laterally displaceable ends of both scissors arms, an assembly is also conceivable, in which an arresting device is only provided on one scissors arm, and only a guide is attached to the displaceably supported end of the other scissors arm. The arresting device can optionally be connected to the displaceably supported top end of a scissors arm and a travel rail or be connected between the laterally displaceable bottom end of a scissors arm and a basement.

FIG. 9A shows a representation of the catch element 100 in lateral view. During the starting height y1, the locking mechanism 201 is located in a first partial region 102, in which the locking element can be engaged with catches 204 which have substantially the same distances to each other. If the lifting platform is lifted beyond a starting value y1, the locking mechanism is located in a second partial region 103, in which the pitch of the catch elements, that is the distances between two adjacent catches 204, continuously increases in the longitudinal direction of the catch element 100.

For better presentability, FIG. 9B shows an enlarged section of the second partial region 103 of the catch element 100. The distances increasing in longitudinal direction between two catches are clearly recognizable by the length values xn+1, xn+2, xn+3.

The pitch, i.e. the distance between two catches, xₙ(n) for n=1 . . . m results from the following formula:

xₙ(n)=L₀−[\sqrt{l_{Arm}²−[y₁+(n·y)]²}]−[L₀−[\sqrt{l_{Arm}²−[y₁+[(n−1)·y]²]}]]. (1)

Therein, l_{Arm} corresponds to the length of a scissors arm of the scissors-type lifting platform, y1 to a starting height and y to the fixedly predefined distance between the catching positions. L₀ designates the position of the first catch which in turn results depending on the starting height y1 from the following formula:

L₀=\sqrt{l_{Arm}²−y₁²}. (2)

The invention is not restricted to the illustrated embodiment. Thus, for example, the operation of the tooth claws can be effected not only by pressure medium cylinders, but also by other drive assemblies, for example electromagnetic or purely mechanic drives. Further, the arrest of the top ends of the one scissors arm on the travel rail can also be effected not only by form-locking locking elements, but also in friction-locking manner, for example by twisting cams, displacing wedges etc. The features mentioned above and the exemplarily described embodiments of the present invention can be combined with each other in arbitrary manner in part or as a whole in order to form further embodiments adapted to corresponding applications of the invention. If such embodiments become apparent to a person skilled in the art from the above-mentioned embodiments, they are to be considered as implicitly disclosed with the above-mentioned embodiments.

1.-25. (canceled)

26. A scissor-type lifting platform comprising:
stationary support rails on or in a floor level;
at least two scissor arms which cross each other and are retained and guided with their bottom ends in the support rails;
a hinge connecting the two scissor arms approximately centrally to each other;
a lifting assembly engaging the scissor arms for spreading and contracting the scissor arms; and
at least one travel rail which includes contact areas and is supported on the top ends of the scissor arms;
wherein one of the scissor arms is connected to a travel rail with its top end in hinged manner and the other scissor arm is guided on the travel rail with its top end in longitudinally displaceable manner upon the lifting and lowering movement of the scissor-type lifting platform, and wherein the longitudinally displaceable ends of the two scissor arms can be arrested with the associated travel rail at least in the lifted position.

27. The scissor-type lifting platform of claim 26 wherein an arresting mechanism is hinged at the top end of the one scissor arm which includes a slide element longitudinally guided on the travel rail and at least one locking element which can be arrested on the travel rail or the guide rail in form-locking or force-locking manner.

28. The scissor-type lifting platform of claim 27 wherein the locking elements are tooth members hingedly supported in a common housing which engage with recesses of toothed racks attached to the respective travel rail in form-locking manner upon swing-out.

29. The scissor-type lifting platform of claim 27 wherein the arresting mechanism includes a rigid housing connected to the locking element via a rotary joint, and a first end region of the force element is connected to the locking element and a second end region of the force element is connected to the housing.

30. The scissor-type lifting platform of claim 27 wherein the locking element includes at least a first tooth and a second tooth and the catches have a first catch unit and a second catch unit, wherein each one first tooth and one second tooth can be engaged with a first catch unit and a second catch unit.

31. The scissor-type lifting platform of claim 27, further comprising a controller, wherein for canceling the engagement between the locking element and a catch, the controller controls the drive assembly such that first a lifting movement and subsequently a lowering movement can be produced, wherein the force element can be controlled by the controller between the end of the first movement and the beginning of the second movement such that the form-locking and/or force-locking engagement of the locking element with a catch of the catch element is releasable.

32. The scissor-type lifting platform of claim 26 wherein the arresting mechanism includes front and rear slide elements guided inside the travel rail as well as front and rear collectively operable locking elements, and the longitudinally displaceable end of the scissor arm is hinged on the center portion of the arresting mechanism approximately symmetrically between the slide elements and the locking elements.

33. The scissor-type lifting platform of claim 26 wherein the locking elements are collectively operable by a drive.

34. The scissor-type lifting platform of claim 33 wherein the drive is an electric, mechanic or fluidic drive.

35. The scissor-type lifting platform of claim 33 wherein the drive is attached to a front end of a housing, on which the slide elements, the locking elements and in the central part a support bearing for a crossbolt are provided.

36. The scissor-type lifting platform of claim 26 wherein attachment elements in the form of cotter pins are provided for height adjustment and calibration of the respective travel rail.

37. The scissor-type lifting platform of claim 26 wherein a toothed rack is attached to each sidewall of each travel rail and the longitudinally displaceable ends of the scissor arms are centrally supported in the associated arresting mechanism.

38. The scissor-type lifting platform of claim 26 wherein an arresting mechanism is hinged on the top and/or bottom end of a scissor arm which includes a locking element which can be arrested on the travel rail or on the guide rail in form-locking and/or force-locking manner, and further comprising a catch element, wherein the catch element includes a plurality of substantially similarly formed catches, and the locking element can be engaged with at least one catch in detachable, form-locking and/or force-locking manner in a plurality of predetermined catching positions, wherein at least a first catching position, a second catching position and a third catching position can be approached by the locking element at least in a partial region of the catch element, wherein at least a first distance between the first catching position and the second catching position and a second distance between the second catching position and the third catching position have different lengths.

39. The scissor-type lifting platform of claim 38 wherein the catch element is connected to the travel rail, the guide rail and/or a workshop floor, wherein the catches of the catch element have a different pitch in the longitudinal direction of the catch element.

40. The scissor-type lifting platform of claim 38 wherein the catch element includes a first partial region, in which the first distance between adjacent catches and the second distance between two adjacent catches are the same, and includes a second partial region, in which the first distance between two adjacent catches and the second distance between two adjacent catches are different, wherein the length values of the distances between each two adjacent catches in the longitudinal direction of the catch element increase or decrease.

41. The scissor-type lifting platform of claim 38 wherein with increasing lifting height of the lifting platform, substantially in a vertical direction, the pitch of the catch element increases substantially in horizontal direction.

42. The scissor-type lifting platform of claim 38 wherein a guide unit is provided which is connected to the catch element such that the locking element can be engaged with the catch element exclusively in predetermined positions.

43. The scissor-type lifting platform of claim 42 wherein the guide unit includes an outer contour and the locking element includes an operating means which can be brought into contact with the contour of the guide unit in predetermined positions, whereby contact between the locking element and the catch element can be prevented in these positions.

44. The scissor-type lifting platform of claim 26, further comprising a controller, wherein the controller controls the lifting assembly during a lifting operation such that the travel rail reaches a first predetermined lifting height by a lifting movement, and after reaching the first predetermined lifting height, it reaches a second predetermined lifting height by a lowering movement.

45. The scissor-type lifting platform of claim 44 wherein after reaching the first predetermined lifting height and during reaching the second predetermined lifting height, the force element of the arresting mechanism can be controlled by the controller such that the locking element can be engaged with the toothed rack in form-locking and/or force-locking manner.

46. A scissor-type lifting platform comprising:
stationary support rails on or in the floor level;
at least two scissor arms which cross each other and are retained and guided with their bottom ends in the support rails;
a hinge connecting the two scissor arms approximately centrally to each other;
a lifting assembly engaging the scissor arms for spreading and contracting the scissor arms;
at least one travel rail including contact areas and supported on the top ends of the scissor arms;
wherein one of the scissor arms is connected to a travel rail with its top end in hinged manner and the other scissor arm is guided on the travel rail with its top end in longitudinally displaceable manner upon the lifting and lowering movement of the scissor-type lifting platform; and
the longitudinally displaceable ends of the two scissor can be arrested with the associated travel rail at least in the lifted position;
wherein an arresting mechanism is hinged on the top and/or bottom end of a scissor arm which includes a locking element which can be arrested on the travel rail or on the guide rail in form-locking and/or force-locking manner, and a catch element, wherein the catch element includes a plurality of substantially similarly formed catches, and the locking element can be engaged with at least one catch in detachable, form-locking and/or force-locking manner in a plurality of predetermined catching positions, wherein at least a first catching position, a second catching position and a third catching position can be approached by the locking element at least in a partial region of the catch element, wherein at least a first distance between the first catching position and the second catching position and a second distance between the second catching position and the third catching position have different lengths.

47. A scissor-type lifting platform comprising:
stationary support rails on or in the floor level;
at least two scissor arms which cross each other and are retained and guided with their bottom ends in the support rails;
a hinge connecting the two scissor arms approximately centrally to each other;
a lifting assembly engaging the scissor arms for spreading and contracting the scissor arms;
at least one travel rail including contact areas and supported on the top ends of the scissor arms;
wherein one of the scissor arms is connected to a travel rail with its top end in hinged manner and the other scissor arm is guided on the travel rail with its top end in longitudinally displaceable manner upon the lifting and lowering movement of the scissor-type lifting platform; and
the longitudinally displaceable ends of the two scissor arms can be arrested with the associated travel rail at least in the lifted position;
wherein an arresting mechanism is hinged on the top and/or bottom end of a scissor arm which includes a locking element which can be arrested on the travel rail or on the guide rail in form-locking and/or force-locking manner, and a catch element, wherein the catch element includes a plurality of substantially similarly formed catches, and the locking element can be engaged with at least one catch in detachable, form-locking and/or force-locking manner in a plurality of predetermined catching positions, wherein at least a first catching position, a second catching position and a third catching position can be approached by the locking element at least in a partial region of the catch element, and
wherein at least a first distance between the first catching position and the second catching position and a second distance between the second catching position and the third catching position have different lengths, the catch element includes a first partial region, in which the first distance between adjacent catches and the second distance between two adjacent catches are the same, and includes a second partial region, in which the first distance between two adjacent catches and the second distance between two adjacent catches are different, wherein the length values of the distances between each two adjacent catches in the longitudinal direction of the catch element increase or decrease.

48. A scissor-type lifting platform comprising:
stationary support rails on or in the floor level;
at least two scissor arms which cross each other and are retained and guided with their bottom ends in the support rails;
a hinge connecting the two scissor arms approximately centrally to each other;
a lifting assembly engaging the scissor arms for spreading and contracting the scissor arms;
at least one travel rail including contact areas and supported on the top ends of the scissor arms;
wherein one of the scissor arms is connected to a travel rail with its top end in hinged manner and the other scissor arm is guided on the travel rail with its top end in longitudinally displaceable manner upon the lifting and lowering movement of the scissor-type lifting platform; and
the longitudinally displaceable ends of the two scissor arms can be arrested with the associated travel rail at least in the lifted position;
wherein an arresting mechanism is hinged on the top and/or bottom end of a scissor arm which includes a locking element which can be arrested on the travel rail or on the guide rail) in form-locking and/or force-locking manner, and a catch element, wherein the catch element includes a plurality of substantially similarly formed catches, and the locking element can be engaged with at least one catch in detachable, form-locking and/or force-locking manner in a plurality of predetermined catching positions, wherein at least a first catching position, a second catching position and a third catching position can be approached by the locking element at least in a partial region of the catch element, wherein at least a first distance between the first catching position and the second catching position and a second distance between the second catching position and the third catching position have different lengths, and
wherein a guide unit is provided which is connected to the catch element such that the locking element can be engaged with the catch element exclusively in predetermined positions.

49. A scissor-type lifting platform comprising:
stationary support rails on or in the floor level;
at least two scissor arms which cross each other and are retained and guided with their bottom ends in the support rails;
a hinge connecting the two scissor arms approximately centrally to each other;
a lifting assembly engaging the scissor arms for spreading and contracting the scissor arms;
at least one travel rail including contact areas and supported on the top ends of the scissor arms, wherein one of the scissor arms is connected to a travel rail with its top end in hinged manner and the other scissor arm is guided on the travel rail with its top end in longitudinally displaceable manner upon the lifting and lowering movement of the scissor-type lifting platform, and wherein the longitudinally displaceable ends of the two scissor arms can be arrested with the associated travel rail at least in the lifted position; and
a controller, by which the lifting assembly can be controlled during a lifting operation such that the travel rail reaches a first predetermined lifting height by a lifting movement, and after reaching this lifting height, it reaches a second predetermined lifting height by a lowering movement.

50. A scissor-type lifting platform comprising:
stationary support rails on or in the floor level;
at least two scissor arms which cross each other and are retained and guided with their bottom ends in the support rails;
a hinge connecting the two scissor arms approximately centrally to each other;
a lifting assembly engaging the scissor arms for spreading and contracting the scissor arms; and
at least one travel rail including contact areas and supported on the top ends of the scissor arms;
wherein one of the scissor arms is connected to a travel rail with its top end in hinged manner and the other scissor arm is guided on the travel rail with its top end in longitudinally displaceable manner upon the lifting and lowering movement of the scissor-type lifting platform, and
wherein the longitudinally displaceable ends of the two scissor arms can be arrested with the associated travel rail at least in the lifted position; wherein an arresting mechanism is hinged on the top end of the one scissor arm which includes a slide element longitudinally guided on the profiled travel rail, and at least one locking element which can be arrested on the travel rail or the guide rail in form-locking or force-locking manner.
